(19) United States
(12) Patent Application Publication
(10) Pub. No.: US 2008/0168036 A1
(43) Pub. Date: Jul. 10, 2008

(54) System and Method for Locating and Extracting Tabular Data

(75) Inventors: Paul K. Young, Ithaca, NY (US); David Quinn-Jacobs, Ithaca, NY (US)

Correspondence Address: TECHNOLOGY, PATENTS AND LICENSING, INC., 2003 South EASTON ROAD, SUITE 208, DOYLESTOWN, PA, 18901, US

(73) Assignee: Graphwise, LLC

(21) Appl. No.: 11/621,773

(22) Filed: Jan. 10, 2007

(51) Int. Cl. G06F 7/10; G06F 17/30

(52) U.S. Cl. 707/3; 707/E17.014

(57) ABSTRACT

A method for searching computer data to obtain tabular data includes selecting a data node and obtaining the data content of the node. Possible tabular data contained within the data content is identified. The possible tabular data is analyzed to recognize tabular data.

### CROSS REFERENCE TO RELATED APPLICATIONS

This application is related to the following copending applications, each of which is incorporated by reference in this application:

U.S. patent application Ser. No. 11/401,673, entitled “Search Engine for Presenting to a User a Display having both Graphed Search Results and Selected Advertisements” (Attorney Docket No. GRA-001-US) filed on Apr. 10, 2006.

U.S. patent application Ser. No. 11/401,677, entitled “A System and Method for Creating a Dynamic Database for use in Graphical Representations of Tabular Data” (Attorney Docket No. GRA-002-US) filed on Apr. 10, 2006.

U.S. patent application Ser. No. 11/401,657, entitled “A System and Method for Presenting to a User a Preferred Graphical Representation of Tabular Data” (Attorney Docket No. GRA-003-US) filed on Apr. 10, 2006.

U.S. patent application Ser. No. 11/401,678, entitled “Search Engine for Evaluating Queries from a User and Presenting to the User Graphed Search Results” (Attorney Docket No. GRA-004-US) filed on Apr. 10, 2006.

U.S. patent application Ser. No. 11/401,812, entitled “Search Engine for Presenting to a User a Display having Graphed Search Results Presented as Thumbnail Presentation” (Attorney Docket No. GRA-005-US) filed on Apr. 10, 2006.

Further, this application is related to the following copending application:

U.S. patent application Ser. No. ______ entitled “System and Method for Ranking Tabular Data” (Attorney Docket No. GRA-008-US) filed on the same date herewith.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BRIEF DESCRIPTION OF THE DRAWINGS

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings.

In the Drawings:

FIG. 1 contains a data flow diagram that depicts an overall view of the processes and major data flows of an embodiment of the present invention;

FIG. 2 contains a data flow diagram that depicts the processes and major data flows of the Content Processor software program of an embodiment of the present invention;

FIG. 3 depicts an exemplary parse tree derived from an HTML file according to an embodiment of the invention;

FIG. 4 depicts the identification of a table contained in the parse tree depicted in FIG. 3; and

FIG. 5 depicts the table that is extracted from the parse tree depicted in FIG. 3.

### DETAILED DESCRIPTION

The present invention relates to a system that identifies, recognizes, extracts and stores tabular data that is obtained from sources on a computer network or on an individual computer. In one embodiment the system crawls a network, applying a set of rules to select data sources that are likely to contain tabular data. This data is then examined to identify, recognize, extract and store tabular information contained within the data.

Certain terminology is used herein for convenience only and is not to be taken as a limitation on the embodiments of the present invention. In the drawings, the same reference letters are employed for designating the same elements throughout the several figures.

It is well known that data flow diagrams can be used to model and/or describe methods and systems and provide the basis for better understanding their functionality and internal operation, as well as describing interfaces with external components, systems and people using standardized notation. When used herein, data flow diagrams are meant to serve as an aid in describing the embodiments of the present invention, but do not constrain implementation thereof to any particular hardware or software embodiments.

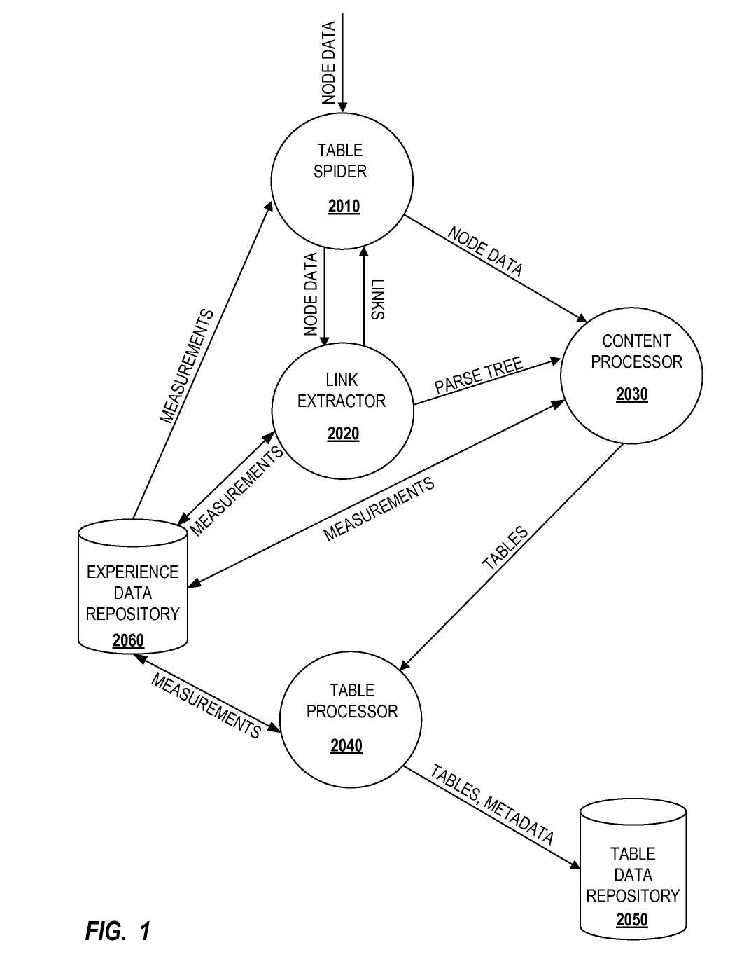

Referring to the drawings in detail, there is shown in FIG. 1 a data flow diagram that illustrates an overview of the processes and major data flows of an embodiment of the invention. The architecture of the depicted embodiment of the invention includes a number of interoperating software programs, potentially distributed across a varying number of computer servers. These software programs include: Table Spider 2010, Link Extractor 2020, Content Processor 2030 and Table Processor 2040. In addition, the depicted embodiment includes a Table Data Repository 2050 and an Experience Data Repository 2060, each which, in alternate embodiments of the invention, may be a dedicated storage device, or may be shared with one or more other systems with which the depicted embodiment of the invention interoperates.

In the embodiment of the invention depicted in FIG. 1, the Table Spider 2010 selects a particular node of a computer network and retrieves data from the node. In a further embodiment, the Table Spider 2010 includes a web crawler component, the implementation of which is well-known in the art, to select the particular nodes from which to retrieve data. The Table Spider 2010 provides the node data to the Content Processor 2030. In addition, if the Table Spider 2010 determines that the node data is in markup format, then the Table Spider 2010 also provides the node data to the Link Extractor 2020. The Link Extractor 2020 parses the node data into a parse tree, extracts links that identify other nodes in the network, and provides these links to the Table Spider 2010 for subsequent data retrieval. In addition, it provides the parse tree to the Content Processor 2030. One or more tables containing tabular information are extracted from the node data by the Content Processor 2030. These tables are provided to the Table Processor 2040 for analysis. The analysis by the Table Processor 2040 yields metadata associated with the tables, which is then stored by the Table Processor 2040 in the Table Data Repository 2050.

In one embodiment of the invention, the computer network is the Internet; in a second embodiment, the computer network is an organization's intranet. In either such embodiment, a node is an Internet or intranet resource, respectively, and a link extracted by the Link Extractor is a Uniform Resource Locator (URL). In a third embodiment, the network is replaced by a single user computer. In such an embodiment, a node is a file (e.g., a spreadsheet) and a link is a URL or a file path (e.g., C:\TEMP\DATA.XLS).

In one embodiment of the invention, the data obtained from a node of the computer network may be in any of the following formats: markup language (e.g., SGML, HTML, XML, or TeX format), office document formats (e.g., Microsoft Office, OpenOffice, PDF, Lotus), database files (e.g., DBase), plain text, character or string delimited exports from database or spreadsheet programs, and formatted vector files that specify Cartesian or geographic coordinates. In a further embodiment of the invention, the data from a node of the computer network may be obtained from a stream of data that is emitted by the node. For example, the data stream may be in a web feed format, such as RSS (Really Simple Syndication).

In one embodiment of the invention, various software programs and components each have an associated goal, and each calculates a degree of belief (DOB) in attaining that goal. A DOB can assume any value between and including 0 and 1. All calculated DOBs are stored in the Experience Data Repository 2060 for subsequent use within the system. If a DOB calculated by a particular program or component is less than an associated threshold value, then that program or component discards the data being processed; otherwise the DOB is stored. This stored DOB is subsequently retrieved from the Experience Data Repository 2060 and used by other programs or components during further processing of that data. For example, a program or component may reduce its initial DOB estimate based on the value of a DOB that was calculated, and stored in the Experience Data Repository 2060, by an upstream program or component.

In one embodiment of the invention, the Table Spider 2010, the Link Extractor 2020, the Content Processor 2030 and the Table Processor 2040 each apply sets of probabilistic (e.g., Bayesian) inferencing rules to determine a DOB. In a further embodiment, the application of each rule results in a value that represents the likelihood that the rule has been met by the node or by the data retrieved from the nodes. In one embodiment, that likelihood is multiplied by a weight associated with that rule. The products of these multiplications are then combined, e.g. summed, to result in a DOB. A weight can assume any value between and including 0 and 1, and a weight may be changed over time based on the received node data. In a further embodiment, a method of backward chaining is used, that is, the application of the rules starts with a list of goals and works backwards to determine if there is evidence in support of any of the goals in the list. For example, for the goal “determine if data obtained from a node contains one or more tables”, the rule “has table begin/end delimiters” would be applied to the data. If the rule is met by the data, then a second rule, e.g., “has row begin/end delimiters” would be applied to the data, and so on.

In one embodiment of the invention, the Link Extractor 2020, the Content Processor 2030 and the Table Processor 2040, while processing the data, calculate measurements which are described in more detail in subsequent paragraphs, and these measurements are stored in the Experience Data Repository 2060. The Table Spider 2010 uses these measurements during the application of its rules.

Individual software programs and components of the embodiment of the invention depicted in FIG. 1 will now be discussed in greater detail.

### Table Spider 2010

In one embodiment of the invention, the Table Spider 2010 applies various rules to determine a DOB that a network node contains tabular data, and adds the node's link to a priority queue, where the priority is based upon the DOB associated with the node. A further function of the Table Spider 2010 is that it crawls the network by selecting the link with the highest priority from the queue (i.e., the link associated with the node having the highest determined DOB), and uses that link to retrieve data from the node. The queue contains the links found in the data obtained from the current and prior nodes; therefore the next link to be crawled is not necessarily from the current node. In one embodiment, a link is not added to the queue if a link to the node identified by that link is already in the queue, since node duplication would result in redundant processing and might cause an infinite loop.

In one embodiment of the invention, the rules applied by the Table Spider 2010 are based on a number of different metrics. The metrics may include previous DOBs of the current node, or of one or more additional related nodes that contain a link that identifies the current node. In one embodiment of the invention, the rules have associated weights that are based on the network domain, subdomain and/or the file format of the node's URL. Examples of a network domain are .gov, .edu and .com. An example of a subdomain isfedstats.gov. Examples of file formats are .xml, .xls and .csv.

In addition, weights are assigned based on particular keyword phrases and/or tags. Examples of tags in the HTML format are <table> (table start), <tr> (row start), and <td> (cell start); an example of a keyword phrase is “Tablefound here”. Over time, the Table Spider 2010 modifies the rule weights based on the presence, in data obtained from network nodes, of particular keyword phrases and tags that are found to be associated with tabular data.

If the Table Spider 2010 determines that the node data is likely to contain tabular data, the node data is provided to the Content Processor 2030, along with the filename, file extension and MIME type of the node.

If the Table Spider 2010 determines that the node data is in markup format, the node data is provided to the Link Extractor 2020. In one embodiment of the invention, the Table Spider 2010 makes such a determination only if the URL of the node terminates in .html or .htm, indicating an HTML document.

### Link Extractor 2020

As described above, in the embodiment of the invention depicted in FIG. 1, the Link Extractor 2020 parses the node data into a parse tree and determines a DOB associated with that parse tree. If that DOB exceeds a particular threshold, then that parse tree is provided to the Content Processor 2030. In addition, the Link Extractor identifies and extracts the links contained within the node data and provides these node links to the Table Spider 2010.

In one embodiment of the invention, the DOB calculated by the Link Extractor 2020 is equal to 0 if there were any non-recoverable parse errors (e.g., if the node data received by the Link Extractor 2020 was in JPEG image format), and equal to 1 otherwise. In a further embodiment, the measurements stored by the Link Extractor 2020 include the number of links contained within the node data.

### Content Processor 2030

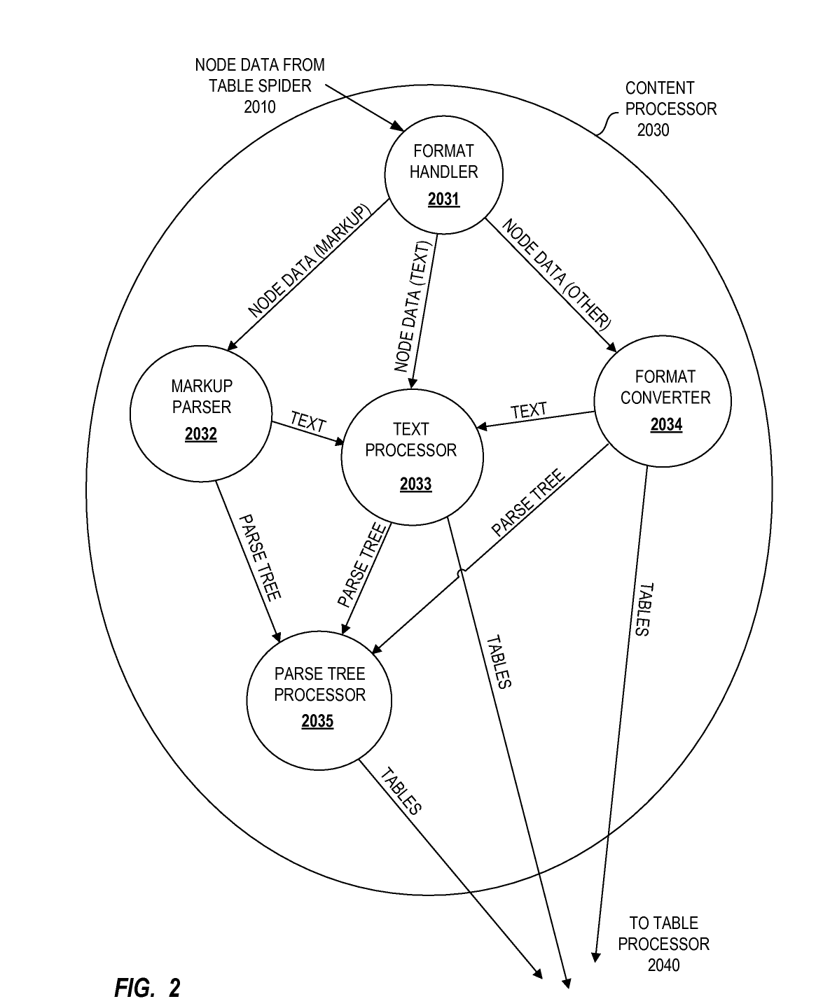

FIG. 2 provides a detailed decomposition of the processes and major data flows within the Content Processor 2030 in accordance with a further embodiment of the invention. The architecture of the depicted embodiment of the Content Processor 2030 includes a number of interoperating software components, potentially distributed across a varying number of computer servers. The Format Handler 2031 determines the format of the node data provided to the Content Processor 2030 by the Table Spider 2010, and provides the node data to the appropriate software component in the Content Processor 2030, e.g., the Text Processor 2033 if the node data is in text format.

In one embodiment of the invention, the DOB calculated by the Content Processor 2030 is equal to the weighted average of the DOBs of all of the tables extracted from the node data. As described above, this DOB is stored in the Experience Data Repository 2060. In a further embodiment, the measurements stored by the Content Processor 2030 into the Experience Data Repository 2060 include the number of sets of tables extracted from the node data, and the DOB and size of each table.

In the embodiment of the invention depicted in FIG. 2, The Format Handler 2031 determines the format of the node data based upon the MIME type and filename extension of the node data, as well as any “magic numbers” contained in the node data. For example, the MIME types for markup data include text/html and text/xml; the MIME types for text data include text/plain and text/csv; and the MIME types for data that is neither markup nor text include application/xls and x-application/pdf. As examples of file extensions, the extensions of markup data include .html and .xml; extensions of text data include .txt; and extensions of data that is neither markup nor text include .xls and .pdf. A “magic number” is a specific signature contained within file data, e.g., a Microsoft Excel spreadsheet file contains the “magic number” 0x00040009 at offset 0.

Based on the format, the Format Handler 2031 provides the node data, MIME type, file extension and “magic number” to one of the following components of the Content Processor 2030: Markup Parser 2032, Text Processor 2033 and Format Converter 2034. In particular, the Markup Parser 2032 receives data formatted in a markup language, the Text Processor 2033 receives text data, and the Format Converter 2034 receives data that is neither markup nor text.

In one embodiment of the invention, the DOB calculated by the Format Handler 2031 is equal to 1 if the MIME type, file extension and “magic number” (if applicable) all correspond to the same file format; otherwise the DOB has a value less than 1.

In the embodiment of the invention depicted in FIG. 2, the Markup Parser 2032 parses HTML or XML markup data into a parse tree which is provided to the Parse Tree Processor 2035. If the Markup Parser 2032 finds a document element, e.g., an HTML <pre> or <div> tag, that contains a large amount of numerical data or that has a large proportion of numerical data relative to the size of the document element, the document element is provided to the Text Processor 2033. The following <div> tag is an example of such a document element:

| <div> | |
|---|---|
| GDP (billions of dollars)<br> | |
| Africa: | 300<br> |
| Asia: | 900<br> |
| Europe: | 1200<br> |
| </div> | |

In one embodiment of the invention, the DOB calculated by the Markup Parser 2032 is equal to 1 if the parsing was successful, and 0 if the parsing failed completely. If there were recoverable parsing errors, then the DOB is based on the number and severity of the errors.

In the embodiment of the invention depicted in FIG. 2, the Text Processor 2033 receives ASCII or Unicode text data, and determines if the data is in a delimited (e.g., Microsoft Excel CSV) or a fixed-width format. If the data is in delimited format, the Text Processor 2033 may parse the data, based on the delimiters, into a parse tree which is provided to the Parse Tree Processor 2035. Alternatively, the Text Processor 2033 converts the delimited data into a table, which is then provided to the Table Processor 2040. If the data is in fixed-width format, the Text Processor 2033 converts the data into a table, which is provided to the Table Processor 2040.

In one embodiment of the invention, the Text Processor 2033 may use the following set of rules to determine the data format:
1. A delimiter is identified by performing a frequency analysis on the characters with the text data. The character with the greatest frequency is identified as the delimiter.
2. If the number of delimiters is equal for each line in the text data, then the data format is determined to be delimited, otherwise,
3. If the number of consecutive delimiters in each row exceeds a particular threshold and the number of columns containing only delimiters exceeds another particular threshold, then the data format is determined to be fixed-width.

In one embodiment of the invention, the Text Processor 2033 may use the following set of rules to convert delimited format data into a table:
1. Calculate the expected (e.g., the average) number of delimiters in a row of the data.
2. If the number of delimiters in a particular data row equals the expected number of delimiters, then add a new row to the table; otherwise the data row is considered to be metadata associated with the table.
3. Populate each cell in the new table row with the corresponding fields of text that are bounded by the delimiters in the data row.

In one embodiment of the invention, the Text Processor 2033 may use the following set of rules to convert fixed-width format data into a table:
1. Determine the positions of the columns in the data that contain only delimiters.
2. Identify the groups of such data columns that contain adjacent columns.
3. In each such group, identify the position of the right-most data column as a position of a table column.
4. If the delimiters in a particular data row are at the position of a table column, then add a new row to the table; otherwise the data row is considered to be metadata associated with the table.
5. Populate each cell in the new table row with the corresponding fields of text that are bounded by the delimiters in the data row, but first remove any additional delimiters on the left or right of the text.

In one embodiment of the invention, the DOB calculated by the Text Processor 2033 is based upon the degree to which the node data matches a fixed-width or delimited format, and the amount of node data that was identified as tabular data.

In the embodiment of the invention depicted in FIG. 2, data received from the Format Handler 2031 that is not text or markup (e.g., PDF or Microsoft Excel formatted data) is supplied to the Format Converter 2034. The Format Converter 2034 determines the format of the data. This determination is based upon the MIME type of the node data, e.g., x-application/pdf or application/xls, the file extension of the node data, e.g., .pdf or .xls, and/or the presence of one or more specific strings in the node data, e.g., “magic numbers”, that would indicate a particular file format. Based on the format and content of the data, the Format Converter 2034 may parse the data into a parse tree which is provided to the Parse Tree Processor 2035. Alternatively, the Format Converter 2034 may extract text data which is then provided to the Text Processor 2033, or the Format Converter 2034 may extract tabular data from the received data and convert the tabular data into a table, which is then provided to the Table Processor 2040. In one embodiment, the extracted text data is originally in a format that is not plain text, e.g., PDF. In that case, the Format Converter 2034 converts the data to a plain text format, e.g., ASCII or Unicode, before providing it to the Text Processor 2033.

In one embodiment of the invention, the DOB calculated by the Format Converter 2034 is equal to the ratio, to the whole, of the portion of node data that was successfully processed. For example, if the Format Converter 2034 receives a PDF Version 1.0.1 file, but is only capable of processing PDF Version 1.0.0, and the Format Converter 2034 encounters unknown tags in the file such that only 80% of the entire file can be processed, then the DOB is 0.8.

In the embodiment of the invention depicted in FIG. 2, the Parse Tree Processor 2035 identifies parse tree nodes that may contain tabular data by applying various heuristic rules on the structure and contents of the candidate data. For example, the following sequence of rules may be applied:
1. If the subtree under a parse tree node contains less than two numerical values, then that node is eliminated from consideration.
2. If a numerical value in the parse tree spans N columns, where N is greater than one (e.g., an HTML <TD colspan=2> tag), then add N-1 empty nodes at the same level as the node that contains the numerical value.
3. For each node which has a depth of two, i.e., which has two levels of nodes beneath it, count the number of children of each child node.
4. If the number of children of each child node is not the same for each child node, but the differences are less than a given threshold, then remove and add nodes as necessary to make the number of children the same for each child node.

A table is recognized within a parse node's subtree if the number of children of each child node is the same for each child node (or has been made the same as described above.) The Parse Tree Processor 2035 then extracts the recognized table from each of the identified parse tree nodes, by assembling the child elements of each child node into a row of the table. In addition, the Parse Tree Processor 2035 extracts metadata (e.g., the row and column headers) from each table, and provides the tables and associated metadata to the Table Processor 2040.

In one embodiment of the invention, the DOB calculated by the Parse Tree Processor 2035 is based upon the ratio of the total amount of extracted tabular data to the total number of numerical values in the parse tree.

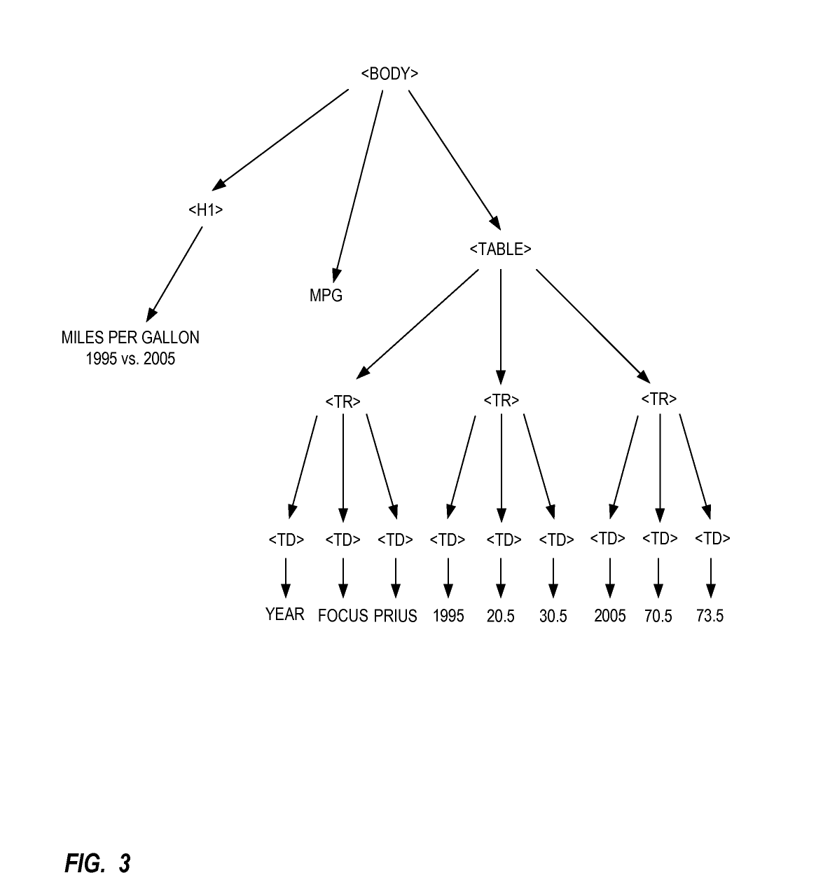

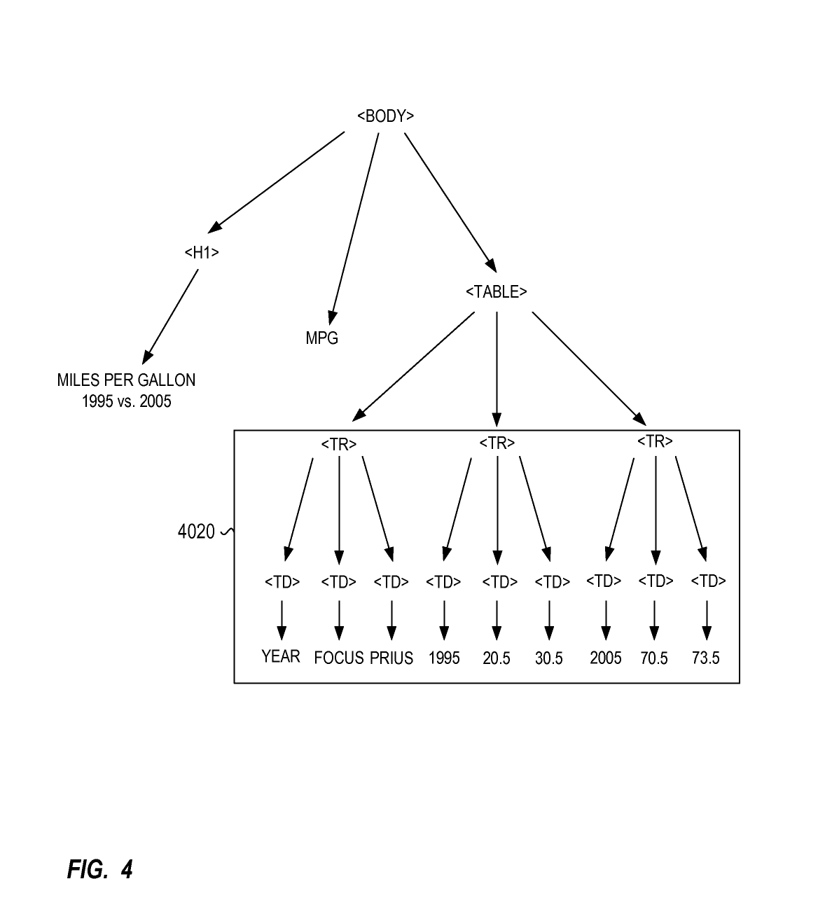

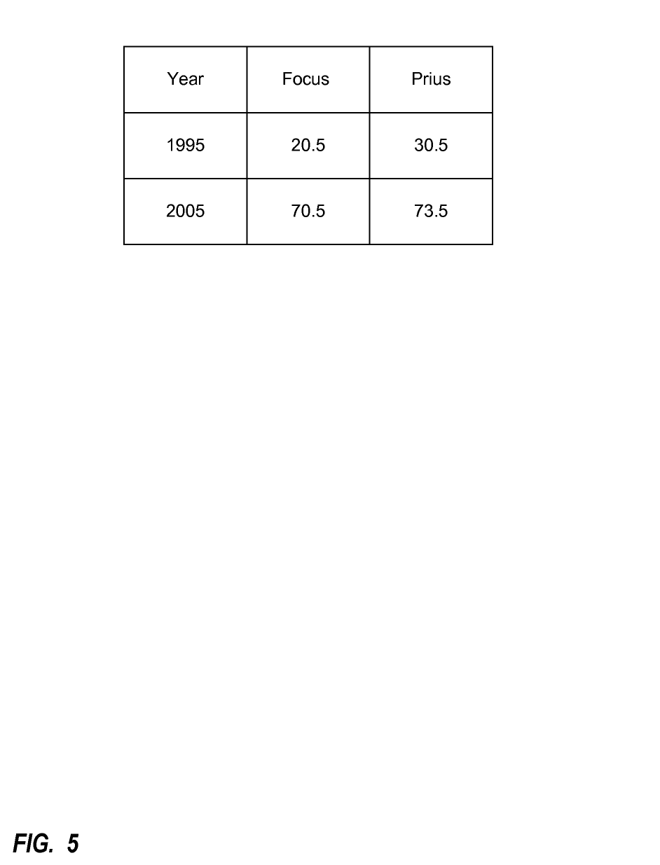

FIGS. 3-5 provide an example of the processing performed on a parse tree by the Parse Tree Processor 2035. FIG. 3 depicts a parse tree that was derived from an HTML file provided to the Parse Tree Processor 2035 by the Markup Parser 2032. The <TABLE> node has three <TR> children, who each have three <TD> children. Since the number of children (i.e., 3) of each child node is the same for each child node of <TABLE>, then the <TABLE> node and subtree is recognized as a table, as shown as item 4020 in FIG. 4. The extracted table, which contains the three column headers “Year”, “Focus” and “Prius” and two rows of numerical data, is shown in FIG. 5.

### Table Processor 2040

As described above, in the embodiment of the invention depicted in FIG. 1, the Table Processor 2040 receives tables from the Content Processor 2030. In one embodiment of the invention, the Table Processor 2040 performs an analysis of the tables which yields additional metadata associated with the tables. This analysis may include:
1. Identification of the data type for each cell in the table, e.g., “plottable types such as “numeric”, “integer”, “floating point” and “scientific notation”, and “label” types such as “time” and “text.” A data type of “time” may be identified by the presence of known date and time formats, e.g., “YYYY” and “YYYY/MM/DD.” The data type may also be identified as “empty”, e.g., if the are no characters in the cell or if the cell contains a “no data” tag, e.g., “−” and “N/A.”
2. Identification of the units associated with each cell in the table, e.g., “kg”, “mm” and “$”.
3. Measurement of the vertical and horizontal runs in each column and row, respectively. A vertical run is calculated by starting at the bottom cell, counting the number of cells in the column that have the same data type as the bottom cell until a different data type is encountered. A horizontal run is calculated similarly, but starting at the rightmost cell and counting within the row.
4. Determination of the row and column headers based on the run analysis. The height and width of the plottable data is obtained by calculating the mode, i.e., most frequently occurring value, of the column and row run measurements, respectively. The remaining columns and rows, after accounting for the height and width of the plottable data, are the column and row headers, respectively. The DOB regarding header determination decreases for each column or row that does not match the height and width, respectively, of the plottable data.
5. Assessment of run consistency. The DOB regarding header determination decreases for each row or column header whose length does not equal or exceed the width or height, respectively, of the plottable data.
6. Assessment of label consistency. The data types of the row and column labels are compared to those in each cell of the corresponding row and column, respectively. The DOB regarding header determination decreases for each data type comparison that does not match, e.g., cell with a data type of “time” would not match the data type of a column labeled “Weight”.
7. If the DOB is less than a particular threshold, repeat the analysis based on more generic data types. For example, if some of the cells in a particular row are “integer”, and others are “floating point”, then the more generic data type “numeric” would be used in the repeated analysis. This would increase the run length of the row, thereby possibly increasing the DOB. In addition, the data types of particular cells may be adjusted in an attempt to achieve a higher DOB. For example, if a particular cell was recognized to have a “year” data type, but the remaining cells in the same column were of the “integer” data type, then the data type of the particular cell would be changed from “year” to “integer.”

The tables and metadata are stored by the Table Processor 2040 in the Table Data Repository 2050. In one embodiment of the invention, this metadata includes the Source of the table, i.e., the title, link (e.g., URL), language (e.g., “Japanese”) and type (Government, Business, Organization or Education) of the node, as well as the row and column headers, domains, dimension and keyword phrases associated with the table. As used herein, “domains” of a table include the type of data (e.g., “time” or “currency”), units of measurement (e.g., “tons”), unit multipliers (e.g., “K” meaning “kilo”), formats (e.g., “scientific notation” or “YYYY-MM-DD), and axis labels, and the “dimension” of a table is the number of rows and columns in the table. Additionally, the metadata may include Plot Specifications and Plots associated with the table. As used herein, a “Plot” is a view into a table that may be presented graphically, and a “Plot Specification” is a set of parameters used to generate a “Plot.”

The tables and metadata stored by the Table Processor 2040 in the Table Data Repository 2050 may be utilized by one or more systems with which the invention interoperates. An example of such a system is the search engine system for querying and displaying structured data described in copending U.S. patent application Ser. No. 11/401,673 entitled “Search Engine for Presenting to a User a Display having both Graphed Search Results and Selected Advertisements.”

The embodiments of the present invention may be implemented with any combination of hardware and software. If implemented as a computer-implemented apparatus, the present invention is implemented using means for performing all of the steps and functions described above.

The embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present invention is not limited to the particular examples and implementations disclosed herein, but is intended to cover modifications within the spirit and scope thereof as defined by the appended claims and any and all equivalents thereof.

I/We claim:

1. A method for searching a computer network to obtain tabular data, the method comprising:
(a) selecting a node belonging to said computer network;
(b) obtaining the data content of said node;
(c) identifying possible tabular data contained within said data content; and
(d) analyzing said identified possible tabular data to recognize tabular data.

2. The method of claim 1, wherein said selecting step comprises using a web crawler to select said node.

3. The method of claim 1, wherein said obtaining step comprises receiving a data stream emitted by said node.

4. The method of claim 1, wherein said obtaining step comprises extracting a plain text representation from said data content.

5. The method of claim 1, wherein said identifying step is based on a file type associated with said data content.

6. The method of claim 1, wherein said identifying step is based on a network domain associated with said node.

7. The method of claim 1, wherein said identifying step is based on a keyword included in said data content.

8. The method of claim 1, wherein said selecting step comprises using one or more values of historical data regarding said node.

9. The method of claim 8, wherein said each of said one or more values of historical data comprise a degree of belief in the presence of tabular data contained within said data content.

10. The method of claim 9, wherein said degree of belief in said method comprises one or more calculations resulting from the application of one or more rules.

11. The method of claim 1, further comprising:
(e) extracting said recognized tabular data.

12. The method of claim 11, further comprising:
(f) storing said extracted tabular data in a repository.

13. A method for searching a computer to obtain tabular data, the method comprising:
(a) selecting a node belonging to said computer;
(b) obtaining the data content of said node;
(c) identifying possible tabular data contained within said data content; and
(d) analyzing said identified possible tabular data to recognize tabular data.

14. An article of manufacture for searching a computer network to obtain tabular data, the article of manufacture comprising a machine-readable medium holding machine-executable instructions for performing a method comprising:
(a) selecting a node belonging to said computer network;
(b) obtaining the data content of said node;
(c) identifying possible tabular data contained within said data content; and
(d) analyzing said identified possible tabular data to recognize tabular data.

15. A system for searching a computer network to obtain tabular data, the system comprising:
(a) an interface for obtaining the data content of a node belonging to said computer network;
(b) a processor for selecting said node belonging to said computer network, identifying possible tabular data contained within the data content of said node, and analyzing said identified possible tabular data to recognize tabular data; and
(c) a storage device for storing said recognized tabular data.
